(19) United States
(12) Patent Application Publication
(10) Pub. No.: US 2009/0111474 A1
(43) Pub. Date: Apr. 30, 2009

(54) SELECTIVE BACKHAUL ROUTING IN HIGH BANDWIDTH WIRELESS COMMUNICATION SYSTEMS

(75) Inventors: Thomas C. Hill, Crystal Lake, IL (US); Troy Dixler, Deerfield, IL (US); Kadathur S. Natarajan, Wilmette, IL (US); Paul D. Steinberg, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/877,727

(22) Filed: Oct. 24, 2007

(51) Int. Cl. H04Q 7/20

(52) U.S. Cl. 455/445; 455/525

(57) ABSTRACT

A method, information processing system, and wireless communication system that selects a set of network paths for transmitting data to a serving network. The method first determines (404) that there is data to transmit to the serving network (102). For each of a plurality of base stations (106, 107, 108), an assessment of at least one traffic engineering parameter associated with each of the base stations (106, 107, 108) is performed (406). A set of base stations in which the traffic engineering parameters satisfy predetermined communication criteria associated with the wireless device (104) is selected (408) in response to performing the assessment. The selected set of base stations is used to transmit wireless device data to the serving network.

### FIELD OF THE INVENTION

The present invention generally relates to the field of wireless communications, and more particularly relates to the dynamic selection of communication sites for transmitting backhaul information to a serving network.

### BACKGROUND OF THE INVENTION

Wireless communication systems have evolved greatly over the past few years. Current wireless communication systems are capable of transmitting and receiving broadband content such as web browsing, streaming video and audio. One communication scheme used in today's wireless communication systems is time division duplex (“TDD”). TDD allows for the transmission and reception of data from a base station to subscriber units on a single frequency band. In TDD systems such as a WiMAX (Worldwide Interoperability for Microwave Access) system there is a traffic type referred to as Backhaul traffic. Backhaul traffic is generated to/from fixed network components such as base stations for transmitting data to the greater serving network.

High bandwidth wireless device systems generally have low site heights in order to provide “spot” high bandwidth coverage. As these systems build out, more sites are added which provide more ubiquitous coverage. One problem with current wireless communication systems is that one or more base stations may not have a fixed (e.g., wired, optical, etc.) link or even a direct wireless link back to the serving network. For example, a base station in a remote area may not include a wired link back to the serving network because of the cost of doing so. The base station may be in such a remote area or a crowded area such as a city where a direct line of sight wireless connection back to the serving network is also not available. Therefore, such a base station may be unable to transmit wireless device data back to the serving network in a cost efficient manner.

Therefore a need exists to overcome the problems with the prior art as discussed above.

### SUMMARY OF THE INVENTION

Briefly, in accordance with an embodiment of the present invention, a method for selecting a set of base stations to transmit wireless device data to a serving network is disclosed. The method includes determining that there is data to transmit to the serving network. For each of a plurality of base stations, an assessment of at least one traffic engineering parameter associated with each of the base stations is performed. A set of base stations in which the traffic engineering parameters satisfy predetermined communication criteria associated with the wireless device is selected in response to performing the assessment.

In another embodiment of the present invention, an information processing system selects a set of base stations to transmit wireless device data to a serving network. The information processing system includes a memory and a processor that is communicatively coupled to the memory. The information processing system also includes a site manager that is communicatively coupled to the memory and the processor. The site manager is adapted to determine that there is data to transmit to the serving network. For each of a plurality of base stations, an assessment of at least one traffic engineering parameter associated with each of the base stations is performed. A set of base stations in which the traffic engineering parameters satisfy predetermined communication criteria associated with the wireless device is selected in response to performing the assessment.

In a further embodiment, a wireless communication system selects a set of base stations to transmit wireless device data to a serving network. The wireless communication system includes a plurality of base stations and a plurality of wireless devices. Each wireless device is communicatively coupled to at least one base station. The wireless communication system also includes at least one information processing system that is communicatively coupled to at least one base station of the plurality of base stations. Also, the wireless communication system, in one embodiment, is communicatively coupled to the serving network. The information processing system comprises a memory and a processor that is communicatively coupled to the memory. The information processing system also includes a site manager that is communicatively coupled to the memory and the processor. The site manager is adapted to determine that there is data to transmit to the serving network. For each of a plurality of base stations, an assessment of at least one traffic engineering parameter associated with each of the base stations is performed. A set of base stations in which the traffic engineering parameters satisfy predetermined communication criteria associated with the wireless device is selected in response to performing the assessment.

In yet another embodiment, a wireless device selects a set of base stations to transmit data to a serving network. The wireless device includes a memory and a processor communicatively coupled to the memory. The wireless device also includes a site monitor communicatively coupled to the memory and the processor, wherein the site monitor is adapted to query the plurality of base stations for current traffic engineering parameter information and analyze parameters received by the plurality of base stations. A site selector is coupled to the site monitor and selects a set of base stations that fulfill traffic constraints defined by either the wireless device or a service provider. Finally, the wireless device includes a transmitter for transmitting the selected set of base stations to a serving base station.

An advantage of the foregoing embodiments of the present invention is that traffic engineering parameters associated with a plurality of base stations can be monitored. Based on the communication parameters, the system is able to dynamically select one or more network paths (sets of base stations) to transmit data to the serving network.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention;

FIG. 2 is a block diagram illustrating a wireless device according to an embodiment of the present invention;

FIG. 3 is a block diagram illustrating an information processing system according to an embodiment of the present invention; and

FIG. 4 is an operational flow diagram illustrating a process of selecting one or more network paths to transmit wireless device data to a serving network.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless device can include any one or a combination of the following: a cellular telephone, a wireless phone, a smartphone, a two-way radio, a two-way pager, a wireless messaging device, a laptop/computer, automotive gateway, residential gateway, wireless interface card, and the like.

Wireless Communication System

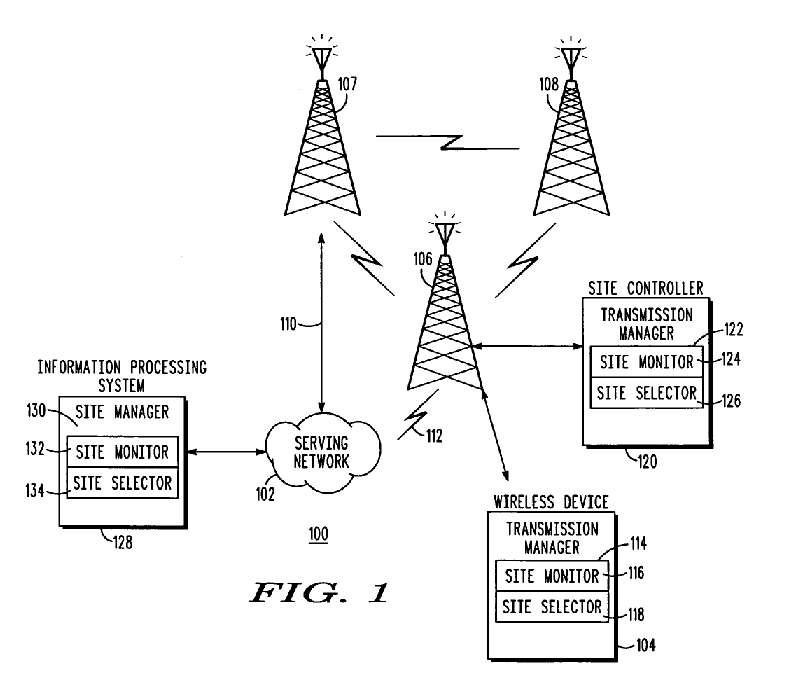

According to an embodiment of the present invention, FIG. 1 shows a wireless communications system 100 comprising a serving network 102. The serving network 102 operates in accordance with communications standards such as Code Division Multiple Access (“CDMA”), Time Division Multiple Access (“TDMA”), Global System for Mobile Communications (“GSM”), General Packet Radio Service (“GPRS”), Frequency Division Multiple Access (“FDMA”), IEEE 802.16 family of standards, Orthogonal Frequency Division Multiplexing (“OFDM”), Orthogonal Frequency Division Multiple Access (“OFDMA”), Wireless LAN (“WLAN”), WiMAX or the like. Other applicable communications standards include those used for Public Safety Communication Networks including TErrestrial TRunked Radio (“TETRA”).

The wireless communications system 100 supports any number of wireless devices 104 which can be single mode or multi-mode devices. Multi-mode devices are capable of communicating over multiple networks with varying technologies. For example, a multi-mode device can communicate over a circuit services network and a packet data network that can be an Evolution Data Only (“EV-DO”) network, a General Packet Radio Service (“GPRS”) network, a Universal Mobile Telecommunications System (“UMTS”) network, an 802.11 network, an 802.16 (WiMax) network, or the like. In one embodiment, the wireless device 104 includes a transmission manager 114, site monitor 116, and site selector 118. Each of these components is discussed in greater detail below.

The wireless communication system 100 also includes one or more base stations 106, 107, 108, that are communicatively coupled to the serving network 102 and one or more wireless devices 104. In the embodiment shown, a base station 107 is directly coupled to the serving network 102 via a wired link 110. Base stations 106, 107, 108 are communicatively coupled to each other and/or the serving network via wireless links. Of course, it should be understood that a single base station may have both a wired and a wireless direct link to the serving network 102. These types of direct communication links are generally referred to herein as direct connections to the serving network 102. In another embodiment, a base station 108 may be communicatively coupled to the serving network 102 via another base station 107. Stated differently, the base station 108 may not have a direct connection to the serving network 102. This type of communication link is referred to herein as an indirect connection to the serving network 102.

Each of the base stations 106, 107, 108, is associated with a site controller 120. While FIG. 1 shows only base station 106 associated with site controller 120, it should be understood that base stations 107 and 108 are also associated with similar site controllers (not shown). Site controller 120 includes a transmission manager 122. The transmission manager 122 includes a site monitor 124 and a site selector 126. Each of these components is discussed in greater detail below.

At least one information processing system 128 is communicatively coupled to the serving network 102, to the base stations 106, 107, 108, and to the one or more wireless devices 104. In the embodiment shown, the information processing system is a centralized entity in the system 100. In another embodiment, the functionality of the information processing system may be distributed and performed by the site controllers for each base station 106, 107, 108. The information processing system 128 includes a site manager 130. The site manager 130 includes a site monitor 132 and a site selector 134. Each of these components is discussed in greater detail below.

Dynamic Selection of Base Stations for Transmitting Wireless Device Data to a Serving Network

In accordance with the present invention, each base station 106, 107, 108 monitors various traffic engineering parameters such as Quality of Service (QoS), real-time, latency, cost, traffic, available bandwidth, and the like. QoS is determined, by given applications requiring a given level of quality to operate at a certain level of reliability for a user of a wireless device. Latency and real-time are trade-off parameters for certain applications which may, or may not, need to be delivered immediately, thus affecting the application adversely. Traffic and bandwidth available to the network service and base stations can limit the type of applications, quality and/or cost of delivering the application. In some cases, applications desired by the user of a wireless device may even be limited where the bandwidth is not available, or the traffic causes congestion, thus reducing available bandwidth.

The present invention may be implemented in a distributed approach or in a centralized approach. In the distributed approach, each base station 106, 107, 108 broadcasts or multicasts its current traffic parameter information to its peer base stations in the system. In one aspect of the invention, the site monitor 124 queries each of the base stations 106, 107, 108, for its current parameter information or receives this information by participation in the aforementioned broadcast or multicast domains. In another aspect, each base station 106, 107, 108 may periodically and autonomously transmit its parameter information to its peer base stations. When a particular base station 106 has data to transmit to the serving network 102, the site selector 126 analyzes the parameters received from other base stations 107,108 and its own parameters. The site selector 126 then determines which base station (or base stations) 107, 108 fulfills a set of parameter constraints associated with the wireless device, including one or more protocol fields that may be defined by the wireless device and/or a service operator.

The protocol fields may be associated with a single parameter such as available bandwidth or associated with a combination of parameters such as, but not limited to, available bandwidth, QoS, current load and reachability. For example, a wireless device 104 or service provider may require that the data associated with a particular communication request be transmitted using bandwidth constrained by or guaranteeing a particular bandwidth threshold and/or at a particular QoS class. Once, the site selector selects the base station to transmit the data to, for example base station 107, the transmission manager 122 of base station 106 transmits the data to base station 107. This process will be repeated at base station 107 and subsequent base stations that data is transmitted to until the data is transmitted to the serving network. The distributed approach allows for the base stations 106,107, 108 in the system to dynamically avoid congestion based on real time traffic parameter information.

The present invention may also be implemented in a centralized approach. In the centralized approach, a single base station may be statically or dynamically defined as a master base station for receiving traffic engineering parameters from peer base stations in the system and communicating the parameters to the information processing system 128. Alternatively, all base stations may communicate their traffic engineering parameters to the information processing system 128. In one aspect of the centralized approach, the site monitor 132 queries one or more of the base stations 106, 107, 108, for current traffic parameter information. In another aspect, one or more base stations 106, 107, 108 may periodically and autonomously transmit current traffic parameter information to the information processing system 128.

The site manager 130 analyzes the parameters communicated by the base station(s) and the site selector 134 selects a set of base stations that a non-wired-link base station can use to transmit data received from a wireless device back to the serving network 102. The selected set of base stations will also be referred to herein as a “network path.” As with the distributed approach, the network path is chosen based on base stations that fulfill a set of parameter constraints associated with the wireless device, including one or more protocol fields that may be defined by the wireless device and/or a service operator. In one embodiment, the final base station that transmits the data to the serving network 102 has a wired link 110 to the serving network 102. In another embodiment, the final base station that transmits the data to the serving network 102 has a wireless link 112 to the serving network 102. Once the network path is chosen, the information processing system 128 notifies the serving base station (base station that the wireless device is currently communicating with or could communicate with) of the selected network path. The serving base station then transmits the wireless device data to the first base station in the network path accordingly. This path is used until a subsequent update is calculated and redistributed.

It should be noted that the centralized approach may be implemented at one of the base stations 106, 107, 108 via its site controller 120 in lieu of the information processing system 128. In such an embodiment, the site controller 120 via its transmission manager 122 determines a set of base stations to transmit wireless device data through to the serving network 102. Similar to embodiments previously described, in one aspect, the site monitor 124 at the site controller 120 queries a group of base stations 106, 107, 108 for their current traffic engineering parameter information. In another aspect, each base station 106, 107, 108 periodically transmits its traffic engineering parameter information to the site controller 120, the serving base station, and other neighboring base stations. This periodic transmission may be driven by a specific timing period or triggered by a poll request initiated by one or more site controllers. Optionally, periodic transmission of parameter information is performed autonomously by each base station 106, 107, 108. This autonomous transmission may be triggered by changes in conditions (available bandwidth, loading, degrading latency, equipment impairments or recovery, etc.).

The traffic engineering parameters are analyzed by the site monitor 124 to identify a set of base stations that can fulfill the traffic constraints defined by the wireless device 104 and/or service operator. Next, the site selector 126 at the site controller 120 selects a set of base stations based on the analysis previously described. The set of base stations is communicated to the serving base station and the wireless device data is transmitted to the base stations in the selected network path accordingly.

It should be noted that in all embodiments described, the information processing system 128 or site controller 120 (whichever applicable) may determine a plurality of network paths for transmitting wireless device data through to the serving network 102. In such a case, the base station 106, 107, 108 that receives the plurality of paths, selects the path that most fulfills the traffic constraints set by wireless device and/or service operator.

In another embodiment of the invention, the wireless device 104 via its transmission manager 114 can select a set of base stations to transmit wireless device data through to the serving network 102. Similar to the embodiments described above, the site monitor 116 at the wireless device 104 queries a group of base stations for their current traffic engineering parameter information. Alternatively, each base station 106, 107, 108 may periodically and autonomously transmits its traffic engineering parameter information to the wireless device 104. The communication parameters are analyzed by the site monitor 116 to identify a set of base stations that can fulfill the traffic constraints defined by the wireless device 104 and/or service operator. The site selector 118 at the wireless device 104 selects a set of base stations based on the above analysis. The transmission manager 114 then transmits the selected set of base stations (the selected network path) to its serving base station. The serving base station then proceeds to transmit the wireless device data to the selected set of base stations received from the wireless device 104. Alternatively, the wireless device 104 may transmit the traffic engineering parameters received from the base stations to its serving base station 106 to perform the dynamic selection process as previously described. As another alternative, the wireless device 104 may transmit a plurality of network paths to its serving base station 106. The serving base station 106 can then analyze each of the network paths and select a network path for transmitting the wireless device data.

The site manager 130 at the information processing system 128, the transmission manager 122 at the site controller 120, and/or the transmission manager 114 at the wireless device 104, can also instruct the serving base station 106 and any base station in a selected network path how the wireless device data is to be transmitted. For example, messages being sent from a site or plurality of sites may be divided into a plurality of messages. At least two of the messages may be sent to a different base station having a wired link 110 back to the serving network 102. It should be noted that the plurality of messages can be sent directly to the base stations having a wired link 110 or can be sent to these base stations through intermediary wireless linked base stations. The base stations having a wired link 110 and the intermediary base stations can each be associated with different traffic engineering parameters.

Similar to the embodiment just described, the messages sent from a base station 106, 107, 108, or plurality of base stations may each be divided into a plurality of messages. However, in contrast to the embodiment just described, the plurality of messages may be multicast, broadcast or transmitted peer to peer to a plurality of additional base stations (which can include hopping through a plurality of intermediary base stations) until base stations with a wired link 110 back to the serving network 102 are reached. If multiple versions of a multicasted message are received, the base stations having the wired link 110 can select the version with the least number of errors to be sent to the serving network. Alternatively, all versions of a message can be sent to the serving network 102 where the serving network 102 reassembles the messages accordingly. This embodiment provides an improvement in dealing with multi-path and other air link errors while providing a high QoS to the network 102.

The current serving base station 106 of a wireless device 104 and/or the base stations within a selected network path may also be instructed to mix various message segments sent from various sites. These mixed segments may then be routed to a base station or a plurality of base stations having a wired link back to the serving network 102. This is different than the above embodiment because multiple messages can be sent from multiple wireless devices and segments of the messages can be combined together. This creates an error correction and cost efficient method of providing higher QoS by having the different message segments interleaved and sent to the base station(s) with a wired link 110.

In another embodiment, the base stations having a wired link 110 are instructed to transmit their availability and type of availability at any given time via multicast, broadcast or peer to peer to base stations that do not have a wired link 110 to the serving network 102. This creates a beacon method of suggesting to non-wired-link 112 base stations the most cost efficient routing of their messages. The non-wired-link 112 base stations can also choose to transmit wireless device data in real-time or non-real-time based on the beacon and the QoS/cost desired. This embodiment provides for a dynamic allocation of QoS for transmitting wireless device data back to the serving network 102. In an alternative embodiment, the wireless device 104, information processing system 128, and/or the non-wired-link base stations query the wired-link base stations with message and QoS requirements. These components can then determine traffic and QoS patterns that provide the most cost effective wired-link site to use (which may not be the closest one).

The base stations 107 having a wired link 110 can also be configured to instruct non-wired-link base stations 106, 108, and wireless devices 104 to begin buffering in order to provide the maximum QoS and/or cost effectiveness backhaul for the appropriate message types. In another embodiment, the site manager 130 at the information processing system 128, the transmission manager 122 at the site controller 120, and/or the transmission manager 114 at the wireless device 104 can determine traffic patterns based on time, location, latency requirements, and service requirements. These determined traffic patterns can be utilized to determine one or more cost effective network path(s).

As discussed above, QoS, bandwidth, and latency can all affect or limit a wireless device application. Conversely, the transmission manager 114 may be able to determine patterns for use of applications with minimal limit on the QoS. Those patterns may include traffic on the network service to the point where one or more changes to the other traffic engineering parameters may allow maximum traffic while retaining high QoS. With respect to patterns that use time, the system may determine that certain times of day have higher network system traffic than others. These patterns can be used to pre-determine network paths. The same can be true of traffic at given locations, thus indicating certain network patterns to the base stations, wireless devices, and transmission manager.

Wireless Device

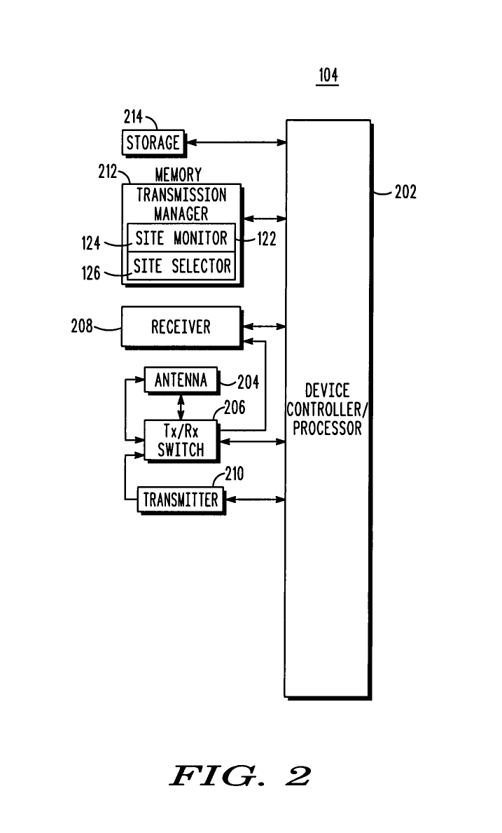

FIG. 2 is a block diagram illustrating a detailed view of an example of the wireless device 104 according to an embodiment of the present invention. It is assumed that the reader is familiar with wireless communication devices. To simplify the present description, only that portion of a wireless communication device that is relevant to the present invention is discussed. The wireless device 104 operates under the control of a device controller/processor 202 that controls transmitting and receiving wireless communication signals. In receive mode, the device controller 202 electrically couples an antenna 204 through a transmit/receive switch 206 to a receiver 208. The receiver 208 decodes the received signals and provides those decoded signals to the device controller 202.

In transmit mode, the device controller 202 electrically couples the antenna 204, through the transmit/receive switch 206, to a transmitter 210. It should be noted that in one embodiment, the receiver 208 and the transmitter 210 comprise a dual mode receiver and a dual mode transmitter for receiving/transmitting over various access networks providing different air interface types. In another embodiment, a separate receiver and transmitter are used for each type of air interface.

The device controller 202 operates the transmitter and receiver according to instructions stored in the memory 212. In one embodiment, the memory 212 includes the transmission manager 122, the site monitor 124, and the site selector 126. The wireless device 104, also includes non-volatile storage memory 214 for storing, for example, an application waiting to be executed (not shown) on the wireless device 104.

Information Processing System

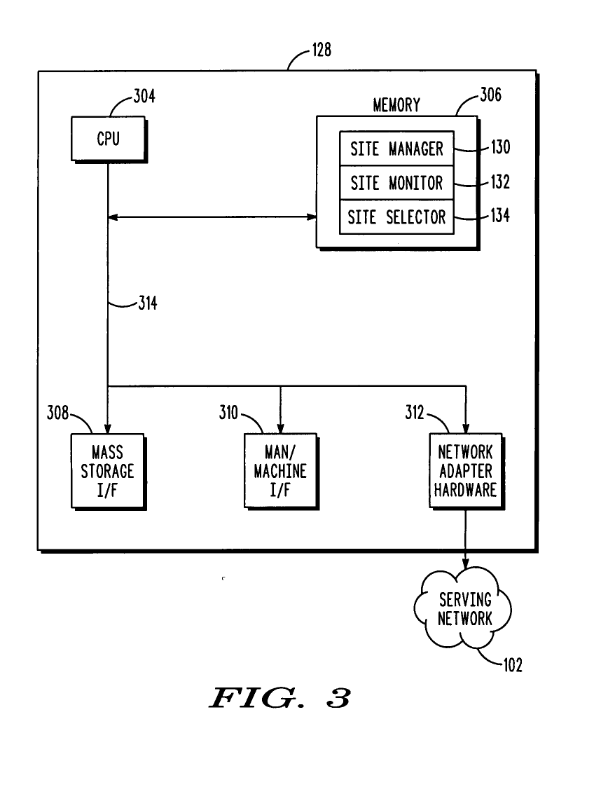

FIG. 3 is a block diagram illustrating a more detailed view of the information processing system 128 according to an embodiment of the present invention. Although the following discussion is provided with reference to the information processing system 128, it is also applicable to the site controller 120. The information processing system 128 is based upon a suitably configured processing system adapted to implement an embodiment of the present invention as discussed herein. For example, a personal computer, workstation, embedded processor/memory or the like, may be used. The information processing system 128 comprises a computer. The computer has a processor 304 that is connected to a main memory 306, a mass storage interface 308, a man-machine interface 310, and network adapter hardware 312 (all of which are commonly known to one of ordinary skill in the relevant art). A system bus 314 interconnects these system components.

The main memory 306 includes the site manager 130, site monitor 132, and the site selector 134. Although illustrated as concurrently resident in the main memory 306, it is clear that respective components of the main memory 306 are not required to be completely resident in the main memory 306 at all times or even at the same time. One or more of these components can be implemented as hardware. The man-machine interface 310 is accessible by an administrator or technician to communicate with the information processing system 128. The network adapter hardware 312 is used to provide an interface to the serving network 102. Embodiments of the present invention anticipate being adapted to work with any data communications connections including present day analog and/or digital techniques or via a future networking mechanism.

Process of Selecting a Base Station for Transmitting Wireless Device Data to a Serving Network

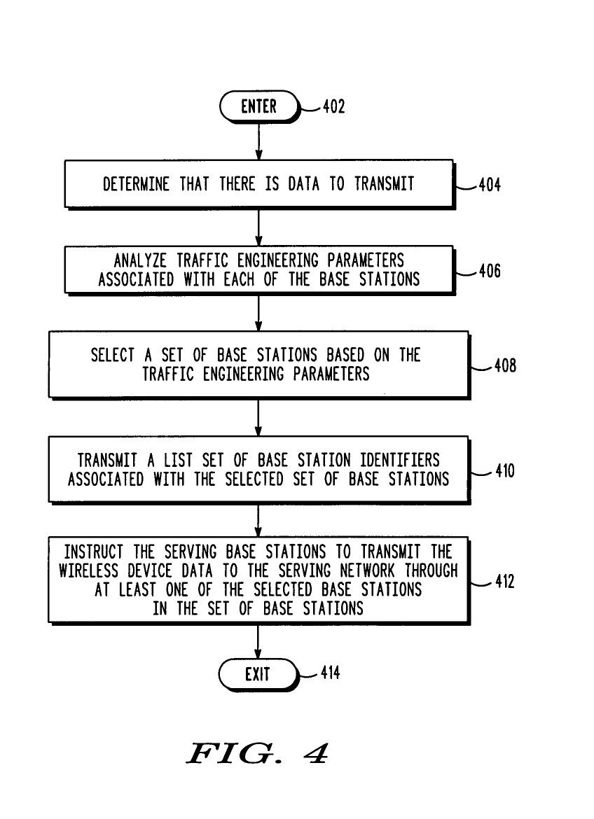

FIG. 4 is an operational flow diagram illustrating an example of a process of selecting a set of network paths for transmitting wireless device data to a serving network. The operational flow diagram of FIG. 4 begins at step 402 and flows directly to step 404. At step 404, at least one of the site manager 130 at the information processing system 128, the transmission manager 122 at the site controller 120, and the transmission manager 114 at the wireless device 104 determines that there is data to send. At step 406, a site manager 130 or a transmission manager 114, 122 assesses at least one traffic engineering parameter associated with a plurality of base stations 106, 107, 108. In the distributed approach, the site monitor at each base station 106,107,108 analyzes parameters received from other base stations and its own parameters. In the centralized approach, the site monitor 132 at the information processing system or site monitor 116 at the wireless device analyzes parameters received from all base stations 106, 107 and 108.

At step 408, the site selector 126, 134 or 118 selects a set of base stations from the plurality of base stations 106, 107, 108 based on the analyzed communication parameters. The set of base stations selected fulfills parameter constraints associated with the wireless device and may include one or more protocol fields defined by the wireless device and/or a service operator. At least one base station 107 of the plurality of base stations may include a wired link 110 back to the serving network 102. As mentioned previously, in one embodiment of the distributed approach, the site selector 126 at each base station may select only the next base station in the network path to transmit the wireless device data to. At step 412, the site manager 130 or transmission manager 114, 122 transmits a list or set of base station identifiers associated with the selected set of base stations to the serving base station 106. At step 414, the site manager 130 or transmission manager 114, 122 instructs the serving base station 106 to transmit the wireless device data to the serving network 102 through at least one base station in the selected set of base stations. The control flow then exits at step 414.

Non-Limiting Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method in a wireless communication system for selecting a set of base stations to transmit wireless device data to a serving network, the method comprising:
determining that there is data to transmit to the serving network;
for each of a plurality of base stations, assessing at least one traffic engineering parameter associated with each of the base stations; and
selecting, in response to performing the assessment, a set of base stations from the plurality of base stations in which the traffic engineering parameters satisfy predetermined communication criteria associated with the wireless device.

2. The method of claim 1, wherein each base station has at least one of a direct connection with the serving network and a connection to another base station in the plurality of base stations.

3. The method of claim 1, wherein the at least one traffic engineering parameter associated with each base station in the set of base stations substantially satisfies the predetermined communication criteria.

4. The method of claim 1, further comprising:
transmitting a set of base station identifiers to the serving base station, wherein each base station identifier is associated with a different base station in the selected set of base stations.

5. The method of claim 4, further comprising:
transmitting, by the serving base station, the wireless device data to the serving network through a set of base stations identified by the set of base station identifiers, wherein at least one of the base stations in the set of base stations comprises a wired link back to the serving network.

6. The method of claim 1, wherein assessing at least one traffic engineering parameter associated with each of the base stations is performed by at least one of:
a wireless device;
a base station of the plurality of base stations; and
an information processing system communicatively coupled with the home base station and with the serving network.

7. The method of claim 1, further comprising:
dividing the wireless device data into a plurality of messages; and
transmitting the plurality of messages to a plurality of base stations in the selected set of base stations, wherein at least two of the messages in the plurality of messages are transmitted to at least two different base stations in the set of base stations.

8. An information processing system for selecting a set of base stations to transmit wireless device data to a serving network, the information processing system comprising:
a memory;
a processor communicatively coupled to the memory; and
a site manager communicatively coupled to the memory and the processor, wherein the site manager is adapted to:
determine that there is data to transmit to the serving network;
for each of a plurality of base stations, access at least one traffic engineering parameter associated with each of the base stations; and
select, in response to performing the assessment, a set of base stations from the plurality of base stations in which the traffic engineering parameters satisfy predetermined communication criteria associated with the wireless device.

9. The information processing system of claim 8, wherein the at least one traffic engineering parameter associated with each base station in the set of base stations substantially satisfies the predetermined communication criteria.

10. The information processing system of claim 8, wherein the site manager is further adapted to:
transmit a set of base station identifiers to the serving base station, wherein each base stationary identifier is associated with a different base station in the selected set of base stations.

11. The information processing system of claim 10, wherein the site manager is further adapted to:
instruct the serving base station to transmit the wireless device data to the serving network through a set of base stations identified by the set of base station identifiers, wherein at least one of the base stations in the set of base stations has a wired link connection back to the serving network.

12. The information processing system of claim 8, wherein the site manager is further adapted to:
instruct the serving base station to divide the wireless device data into a plurality of messages; and
instruct the serving base station to transmit the plurality of messages to a plurality of base stations in the selected set of base stations, wherein at least two of the messages in the plurality of messages are transmitted to at least two different base stations in the set of base stations.

13. A wireless communication system for selecting a set of base stations to transmit wireless device data to a serving network, the wireless communications system comprising:
a plurality of base stations;
a plurality of wireless devices, wherein each wireless device is communicatively coupled to at least one base station in the plurality of base stations;
and at least one information processing system communicatively coupled to at least one base station in the plurality of base stations, wherein the at least one information processing system comprises:
a memory;
a processor communicatively coupled to the memory; and
a site manager communicatively coupled to the memory and the processor, wherein the site manager is adapted to:
determine that there is data to transmit to the serving network;
for each of a plurality of base stations, access at least one traffic engineering parameter associated with each of the base stations; and
select, in response to performing the assessment, a set of base stations from the plurality of base stations in which the traffic engineering parameters satisfy predetermined communication criteria associated with the wireless device.

14. The wireless communication system of claim 13, wherein each base station connection has one of a direct connection with the serving network and a connection to another base station in the plurality of base stations.

15. The wireless communication system of claim 13, wherein the at least one traffic engineering parameter associated with each base station in the set of base stations substantially satisfies the predetermined communication criteria.

16. The wireless communication system of claim 13, wherein the site manager is further adapted to:
transmit a set of base station identifiers to the serving base station, wherein each base station identifier is associated with a different base station in the selected set of base stations.

17. The wireless communication system of claim 16, wherein the site manager is further adapted to:
instruct the serving base station to transmit wireless device data to the serving network through a set of base stations identified by the set of base station identifiers, wherein at least one of the base stations in the set of base stations has a wired link back to the serving network.

18. The wireless communication system of claim 13, wherein the site manager is further adapted to:
instruct the serving base station to divide wireless device data into a plurality of messages; and
instruct the serving base station to transmit the plurality of messages to a plurality of base stations in the selected set of base stations, wherein at least two of the messages in the plurality of messages are transmitted to at least two different base stations in the set of base stations.

19. The wireless communication system of claim 19, wherein the serving base station transmits the plurality of messages to a plurality of base stations by multicasting the plurality of messages to the plurality of base stations, and wherein at least two of the messages in the plurality of messages are multicasted to at least two different base stations in the set of base stations.

20. A wireless device for selecting a set of base stations from a plurality of base stations to transmit data to a serving network, the wireless device comprising:
a memory;
a processor communicatively coupled to the memory;
a site monitor communicatively coupled to the memory and the processor, wherein the site monitor is adapted to query the plurality of base stations for current traffic engineering parameter information and analyze parameters received by the plurality of base stations;
a site selector coupled to the site monitor for selecting the set of base stations from the plurality of base stations that fulfill traffic constraints defined by one of the wireless device and a service provider; and
a transmitter coupled to the processor for transmitting the selected set of base stations to a serving base station of the plurality of base stations.
